(19) United States
(12) Patent Application Publication
(10) Pub. No.: US 2019/0130237 A1
(43) Pub. Date: May 2, 2019

(54) A radio frequency identification (RFID) tag and a method for limiting supply voltage of a RFID tag

(71) Applicant: FARSENS, S.L., Gipuzkoa (ES)

(72) Inventors: Andoni Beriain Rodriguez, Guipuzcoa (ES); Ibon Zalbide Aguirrezabalaga, Guipuzcoa (ES); Ainara Jimenez Irastorza, San Sebastian (ES); Inaki Galarraga Martin, Guipuzcoa (ES); Roque Jose Berenguer Perez, Guipuzcoa (ES); Aritz Alonso Domingo, Guipuzcoa (ES); Ezequiel Navarro Perez, Malaga (ES)

(73) Assignee: FARSENS, S.L., Gipuzkoa (ES)

(21) Appl. No.: 16/095,602

(22) PCT Filed: Apr. 20, 2017
(86) PCT No.: PCT/IB2017/000437

§ 371 Date: Oct. 22, 2018

(30) Foreign Application Priority Data
Apr. 22, 2016 (EP) EP 16000910.6

(51) Int. Cl. G06K 19/07; G06K 7/00

(52) U.S. Cl. CPC G06K 19/0715; G06K 7/0008; G06K 19/0712; G06K 19/0723

(57) ABSTRACT

The RFID tag comprising: a first communication module (201) for extracting energy from received signals from a RFID reader providing a supply voltage VDD to the RFID tag (200); an energy storage module (203) to store said extracted energy from the received signals; a first voltage limiter (205) adapted and configured to limit, during a start-up state of the RFID tag (200), said supply voltage VDD; and a second voltage limiter (206), different to and synchronized with said first voltage limiter (205), said second voltage limiter (206) being adapted and configured to be enabled during a stationary state of the RFID tag (200) by switching from the first voltage limiter (205) to the second voltage limiter (206), the first voltage limiter (205) having a fast response time and the second voltage limiter (206) having high and accurate limitation voltage in powered operation.

### TECHNICAL FIELD

The present invention is directed, in general, to the field of radio frequency identification technology. In particular, the invention relates to a radio frequency identification (RFID) tag and a method for limiting supply voltage of a RFID tag, accurately, by controlling the power consumption thereof.

### BACKGROUND OF THE INVENTION

Power consumption of a passive or semi-passive RFID tag should be low. However, given that these type of tags include a voltage limiter in order to avoid breaking the technology in presence of excessive voltage caused by excessive input power, their power consumption increases with the voltage.

When an external device, e.g. a battery, is connected to the RFID tag to make it function in Battery Assisted Passive (BAP) mode, the maximum battery voltage that can be used is limited by the limitation voltage of the RFID tag.

In order to accept a wide range of battery types assuring low current drain from the external device, the limitation voltage has to be as high as possible. However, in order to protect the device from high input power scenarios, a fast response time of the voltage limiter is required.

Unfortunately, usually in passive or semi-passive RFID tags there is a trade-off between limitation voltage precision and response time. The faster the response time, greater the variability of the limitation voltage, and thus lower the maximum acceptable battery voltage.

Present invention is focused on solving such a technical problem.

There are known some patents in this technical field.

U.S. Pat. No. 7,482,930 B2 discloses a limiter for controlling an overvoltage in an RFID tag. The limiter includes a first limiter part and a second limiter part serially connected to the first limiter part. The second limiter part has at least one limit diode whose threshold voltage is lower than that of elements in the first limiter part. Accordingly, if an overvoltage is input, the limiter can maximize the input current drop so that the limiter can maximize the leakage voltage. As a result, the RFID tag can prevent the RFID driving part from being damaged due to the overvoltage. In addition, the RFID tag can normally operate regardless of the intensity of the driving voltage input from the RFID reader, so that the yields of products can improve.

U.S. Pat. No. 7,839,210 B2 discloses a method and a circuit for detecting a radio-frequency signal, including at least one first MOS transistor with a channel of a first type, having its gate coupled to an input terminal capable of receiving said signal; a circuit for biasing the first transistor, capable of biasing it to a level lower than its threshold voltage; and a circuit for determining the average value of the current in the first transistor.

U.S. Pat. No. 6,304,613 B1 discloses a data carrier processing system for receiving an amplitude-modulated carrier signal which has been modulated in dependence on data to be transmitted. The system includes rectifier means which are adapted to generate a d.c. supply voltage corresponding to the received amplitude-modulated carrier signal and voltage limiter means adapted to limit the d.c supply voltage generated with the aid of the rectifier means to a first limit value, and amplitude demodulation means. Such a data carrier has the problem that the voltage limiting means counteract the amplitude modulation in the amplitude-modulated carrier signal received which results in the amplitude modulation being evened out. This evening out during the demodulation is equivalent to a reduction of the modulation percentage and may lead to problems, as a result of which errors may occur in the data signal representing the data to be transmitted. To preclude the afore mentioned problem the limiting means include a first voltage limiting stage which responds with a delay to amplitude variations in the received amplitude-modulated carrier signal TS in dependence on a delayed first control signal S1 supplied by a first control signal generating means. The limiting means further include a second voltage limiting stage that respond without delay to amplitude variations in the received amplitude-modulated carrier signal TS in dependence on a second control signal S2 supplied by a second control signal generating means. Unlike present invention, the system of this US patent doesn't include two independent voltage limiters synchronized (via a common controller and in order to switch from one to another voltage limiter), one voltage limiter working during a start-up state of the RFID tag and having a fast response and the other during a stationary state and having an accurate limitation voltage, i.e. with a lower response but more precise.

However, none of the current prior art documents solves the above mentioned technical problem arising from the trade-off between limitation voltage precision and response time in a passive or semi-passive RFID tag.

### DESCRIPTION OF THE INVENTION

An object of the present invention is to provide a radio frequency identification (RFID) tag, which as commonly in the field comprises:

a first communication module adapted and configured to receive signals (e.g. RF signals) from a RFID reader, said first communication module including means for extracting energy from the received signals providing a supply voltage VDD to the RFID tag;

at least one energy storage module in connection with and supplied by the first communication module adapted and configured to store said extracted energy from the received signals of the RFID reader;

a first voltage limiter adapted and configured to limit said supply voltage VDD in order the latter not exceeding a given first threshold voltage value of the first voltage limiter comprised in a region between two given lower and upper voltage thresholds; and

a second voltage limiter, different to said first voltage limiter, adapted and configured to limit the supply voltage VDD in order the latter not exceeding a given second threshold voltage value of the second voltage limiter comprised in a region between two given lower and upper voltage thresholds.

Different to the known proposals, and in a characteristic manner, the first voltage limiter operates without a reference voltage of internal circuitry of the RFID tag during a start-up state thereof. Moreover, the second voltage limiter is synchronized with said first voltage limiter to switch, after a stabilization state of the RFID tag has been reached, from the first voltage limiter to the second voltage limiter. The second voltage limiter is enabled during a stationary state of the RFID tag in which a reference voltage signal VBG is available in the internal circuitry of the RFID tag, said reference voltage signal being used for said switching. According to the proposed RFID tag, the first voltage limiter has a fast response time and the second voltage limiter has high and accurate limitation voltage in powered operation, so that the supply voltage VDD of the RFID tag is always kept below the given second threshold voltage value of the second voltage limiter, the given second threshold voltage value having a given margin of tolerance.

According to the invention, the RFID tag may be passive, i.e. it does not include a battery and it depends on the strength of the RFID reader signal to cause to generate a response, or alternatively it may be semi-passive, i.e. it operates similarly to the passive tag, using the reader signal to cause a response from the tag, however in this case the semi-passive tag does have a battery for sensing or other functions, but not for data transmission.

According to an embodiment, the RFID also includes a digital logic controller in connection with the first and second voltage limiters to control the operation thereof during the start-up state and the stationary state of the RFID tag.

Preferably, both the first and second voltage limiters are circuits connected in parallel.

In addition, the given lower and upper voltage thresholds of the first voltage limiter preferably are 1.2 V and 3.6 V, respectively, and the given second threshold voltage value with the given margin of tolerance of the second voltage limiter preferably is 3.3 V±50 mV. FIG. 7 exemplifies this high variability of the limitation voltage during the star-up state/stage, when the first voltage limiter operates without a reference voltage and the very narrow margin of the limitation voltage during the stationary state, once a reference signal available that is used by the second voltage limiter.

According to an embodiment, the first and second voltage limiters comprise one or more Zener diodes.

According to an embodiment, the first voltage limiter comprises a first stage dependent on a CMOS transistor threshold voltage arranged to generate a trigger signal when the supply voltage VDD exceeds said given first threshold voltage value of the first voltage limiter; a second stage arranged to multiply and rectify said generated trigger signal; and a third stage controlled by said second stage via a transistor that sinks a current from said supply voltage VDD maintaining its value below the given first threshold voltage value of the first voltage limiter.

Moreover, according to an embodiment, the second voltage limiter comprises a first stage including a comparator between said reference voltage signal VBG and a voltage VDDO proportional to said supply voltage VDD triggering an output signal when the supply voltage VDD is at least greater than said given second threshold voltage value; a second stage arranged to multiply and rectify said triggered output signal; and a third stage controlled by said second stage via a transistor that sinks a current from said supply voltage VDD maintaining its value below the given second threshold voltage value.

According to yet another embodiment, the proposed RFID tag may further include a second communication module adapted and configured to communicate with at least one external device (e.g. a sensor, an actuator or any other device consuming energy), and a power output in connection with and supplied by the second communication module adapted and configured to provide a power-supply voltage to said remote device using said stored energy.

It is accordingly an object of the present invention to provide also a method for limiting supply voltage of a RFID tag, the method comprising receiving, by a first communication module of said RFID tag, signals from a RFID reader, and extracting energy from the received signals providing a supply voltage VDD to the RFID tag; storing in at least one energy storage module of the RFID tag said extracted energy from the received signals of the RFID reader; providing via a power output in connection with and supplied by a second communication module of the RFID tag a power-supply voltage to an external device using said stored energy; limiting, by a first voltage limiter said supply voltage VDD in order the latter not exceeding a given first threshold voltage value of the first voltage limiter comprised in a region between two given lower and upper voltage thresholds; and limiting, by a second voltage limiter different to said first voltage limiter, said supply voltage VDD in order the latter not exceeding a given second threshold voltage value of the second voltage limiter comprised in a region between two given lower and upper voltage thresholds.

Characteristically, in the proposed method, the first voltage limiter operates without a reference voltage of internal circuitry of the RFID tag during a start-up state thereof, i.e. a state comprising a time period in which the RFID tag powers up charging the energy storage module to a given voltage value and stabilizes. Besides, the second voltage limiter is synchronized with said first voltage limiter, and is activated/enabled during a stationary state of the RFID tag by switching from one voltage limiter to the other.

So, two different synchronized voltage limiters are used, the first one having a fast response time and the second one having high and accurate limitation voltage. Therefore, the supply voltage VDD of the RFID tag is kept below said given second threshold voltage value of the second voltage limiter, the given second threshold voltage value having a given margin of tolerance.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIG. 1 is a schematic illustration of a preferred embodiment of the proposed RFID tag.

FIG. 2 is a schematic illustration of another embodiment of the proposed RFID tag.

FIG. 3 is a schematic illustration of the two different voltage limiters by the present invention to control power consumption of the proposed RFID tag.

FIG. 4 illustrates an embodiment of the first voltage limiter.

FIG. 5 illustrates an embodiment of the second voltage limiter.

FIG. 6 is a flow chart illustrating a method for limiting power consumption of a RFID tag according to an embodiment of the present invention.

FIG. 7 is a graphic illustrating the high variability of limitation voltage by the first voltage limiter during a start-up state of the RFID tag and the low variability of limitation voltage of the second voltage limiter during a stationary state.

### DETAILED DESCRIPTION OF PREFERRED EMBODIMENTS

With reference to FIG. 1, this figure illustrates a preferred embodiment of the proposed RFID tag 200. According to this particular embodiment, the RFID tag 200 is a passive RFID tag, i.e. the RFID tag does not include a battery, and includes a communication module 201 (or first communication module), which is operatively connected to an energy storage module 203 such as a capacitor.

The first communication module 201 is configured to receive signals such as UHF RF signals from a RFID reader 100 (also illustrated in the figure), extracting energy from the received signals providing a supply voltage VDD to the RFID tag 200. The energy extracted from the received signals from the RFID reader 100 is stored by the energy stored module 203, i.e. the capacitor is charged.

In addition, the proposed RFID further includes two different voltage limiters 205 and 206 (first and second voltage limiters respectively) which are synchronized to obtain a fast response during a start-up of the RFID tag 200 and an accurate limiting value in powered operation of the RFID tag 200. We will refer as start-up process to the time period in which the RFID tag 200 powers up charging the energy storage module to a given voltage value, preferably 1.2V, and stabilizes. We will refer to the state after the RFID tag 200 has been powered on and stabilized as stationary state. In the stationary state, a reference voltage is available in the internal circuitry of the RFID tag 200. This reference voltage is not available during the start-up process. A graphic example of the start-up and stationary states is shown in FIG. 7.

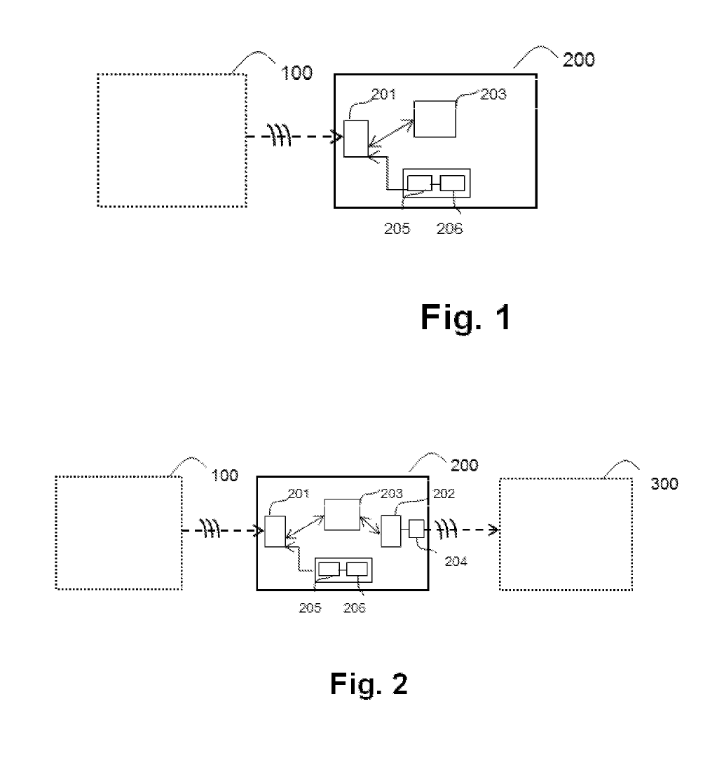

FIG. 2 illustrates another embodiment of the proposed RFID tag 200. In this case the proposed RFID tag 200 in addition to the elements previously described further includes a communication module 202 (or second communication module) which is connected to the energy storage module 203. A power output 204 in connection with and supplied by the second communication module 202 is also included. The second communication module 202 is provided for the communication with at least one external device 300 (e.g. a sensor, among others), and the power output 204 is provided for driving said external device 300 from the energy harvested (i.e. stored) by the RFID tag 200.

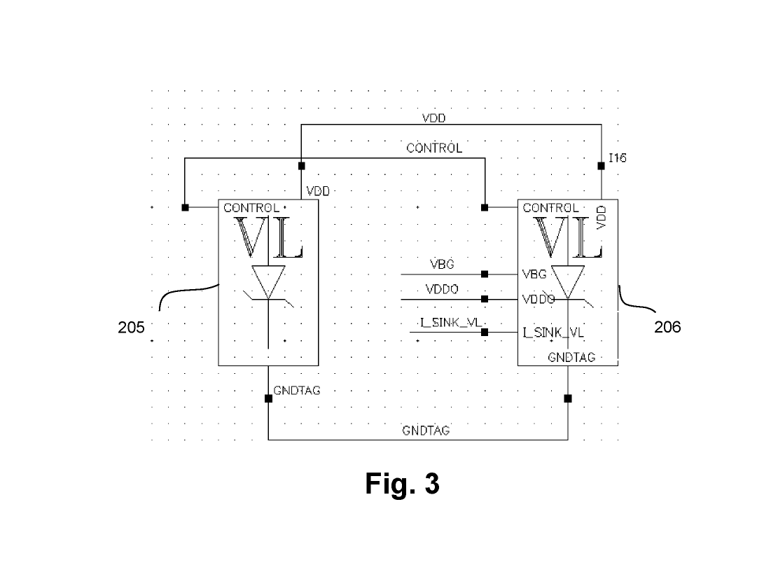

Referring now to FIG. 3, therein it is illustrated an embodiment of the two different voltage limiters 205, 206 which are connected in parallel. The first voltage limiter 205 is enabled during the start-up of the RFID tag 200, whereas the second voltage limiter 206 is enabled during the stationary state of the RFID tag 200. A voltage reference of the RFID tag 200 provides a “reference OK” signal (in the FIG. 3, called “CONTROL”), that is used to switch from one limiter to the other taking into account that both limiters are synchronized. A digital logic controller can be used to provide said CONTROL signal.

For the start-up process of the RFID tag 200, it is necessary to protect the RFID tag 200 with the first voltage limiter 205 ensuring that the supply voltage VDD does not exceed a given first threshold voltage value comprised in a region between two given voltage thresholds, a lower one of preferably 1.2V and an upper one of preferably 3.6V. Reaction time of the first voltage limiter 205 has to be fast enough to ensure that the supply voltage VDD is always below said upper voltage value (i.e. below 3.6V) for the maximum input power supported by the RFID tag 200, which is 20 dBm, and the minimum value of the capacitor, which is 1 nF.

For the stationary state of the RFID tag 200, a second voltage limiter 206, more accurate than the first voltage limiter 205, is used. The second voltage limiter 206 keeps the supply voltage VDD of the RFID tag 200 below a given second threshold voltage value with a given margin of tolerance. Preferably, this given limiting threshold voltage value is 3.3V±50 mV. In this case, a voltage reference signal VBG is required.

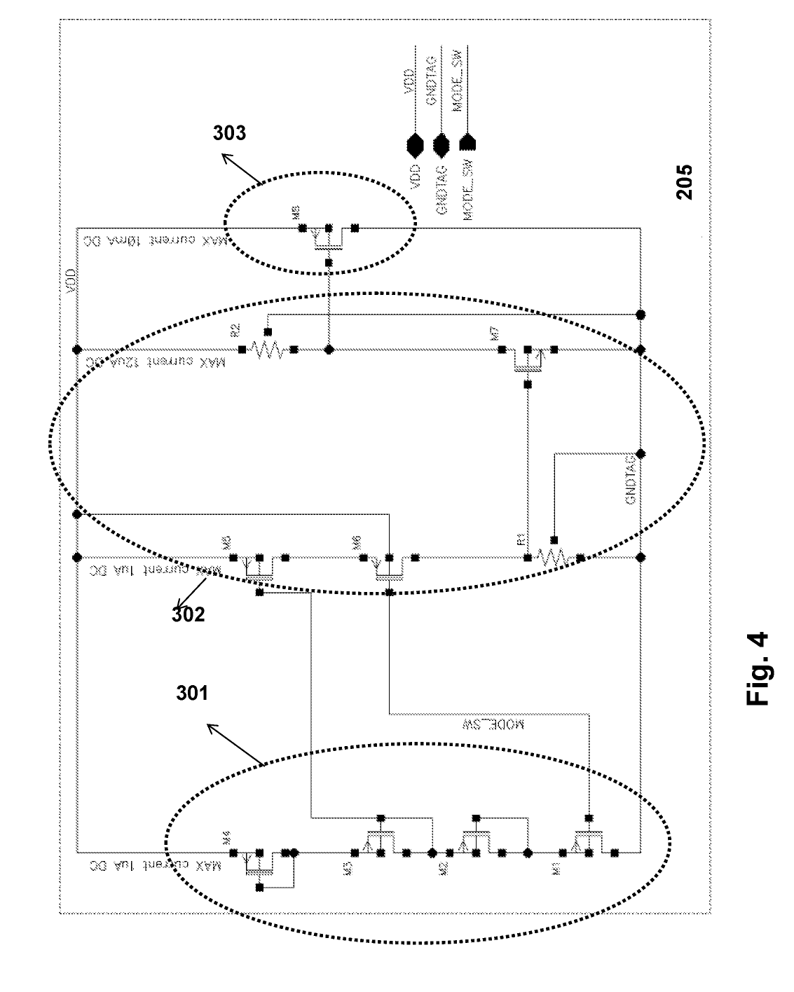

FIG. 4 illustrates a preferred embodiment of the first voltage limiter 205. According to this embodiment, the first voltage limiter 205 comprises a first stage 301 dependent on a CMOS transistor threshold voltage arranged to generate a slow trigger signal when the supply voltage VDD exceeds (in some alternatives embodiments it could be when it is also equal) said not exceeding said given first threshold voltage value of the first voltage limiter 205; a second stage 302 arranged to multiply and rectify said generated trigger signal so the limiter answer is fast; and a third stage (303), or output stage, controlled by said second stage 302 via a transistor that sinks a current from said supply voltage VDD maintaining its value below the given first threshold voltage value of the first voltage limiter 205.

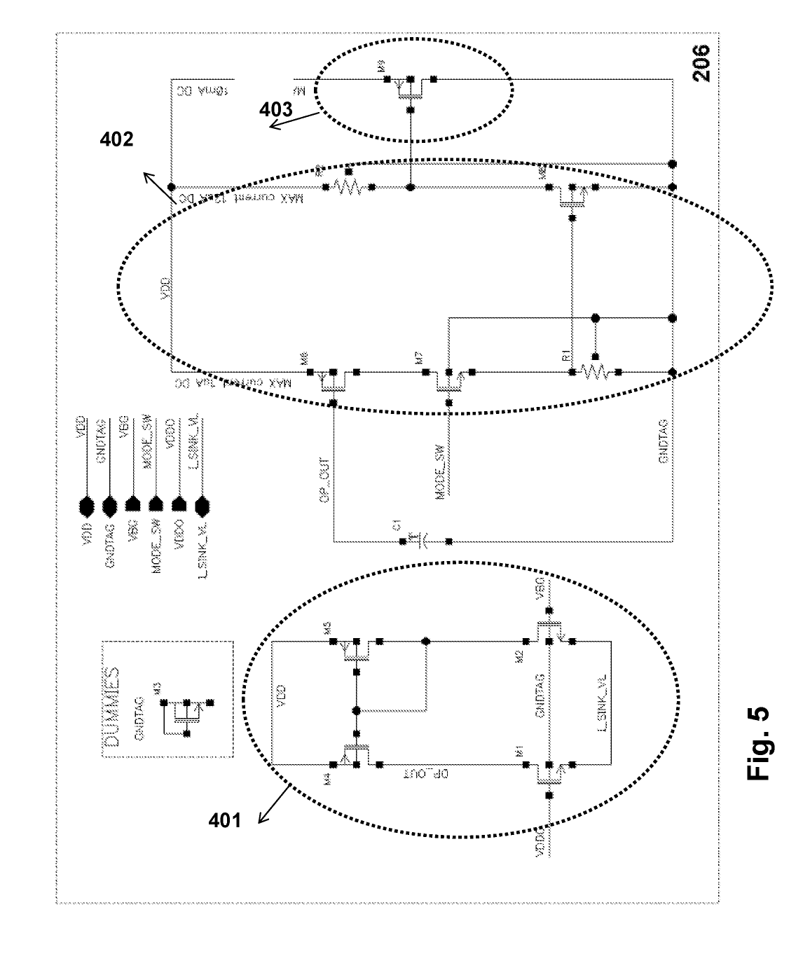

FIG. 5 illustrates a first embodiment of the second voltage limiter 206. According to this embodiment, the second voltage limiter 206 comprises a first stage 401 including a comparator between the reference voltage signal VBG and a voltage VDDO proportional to said supply voltage VDD triggering an output signal when the supply voltage VDD is at least greater (in some alternatives embodiments it could be when it is also equal) than said given second threshold voltage value; a second stage 402 arranged to multiply and rectify said triggered output signal; and a third stage 403, or output stage, controlled by said second stage 402 via a transistor that sinks a current from said supply voltage VDD maintaining its value below the given second threshold voltage value.

Still in another embodiment, not illustrated, and taking into account that stages 302 and 402 include the same group of components and perform the same function (multiply and rectify a triggered output signal, and control by switching the output stages: 303, 403), only one group of components (transistors and resistances) could be used, i.e. one single stage sharing functionality and operating alternatively as said second stages of each voltage limiter.

According to another embodiment, in this case not illustrated, the first and second voltage limiters comprise one or more Zener diodes.

According to another embodiment, in this case not illustrated either, the proposed RFID tag 200 of FIGS. 1 and 2 is a semi-passive RFID tag. In this case, the RFID tag 200 further includes a battery for sensing or other functions, but not for data transmission.

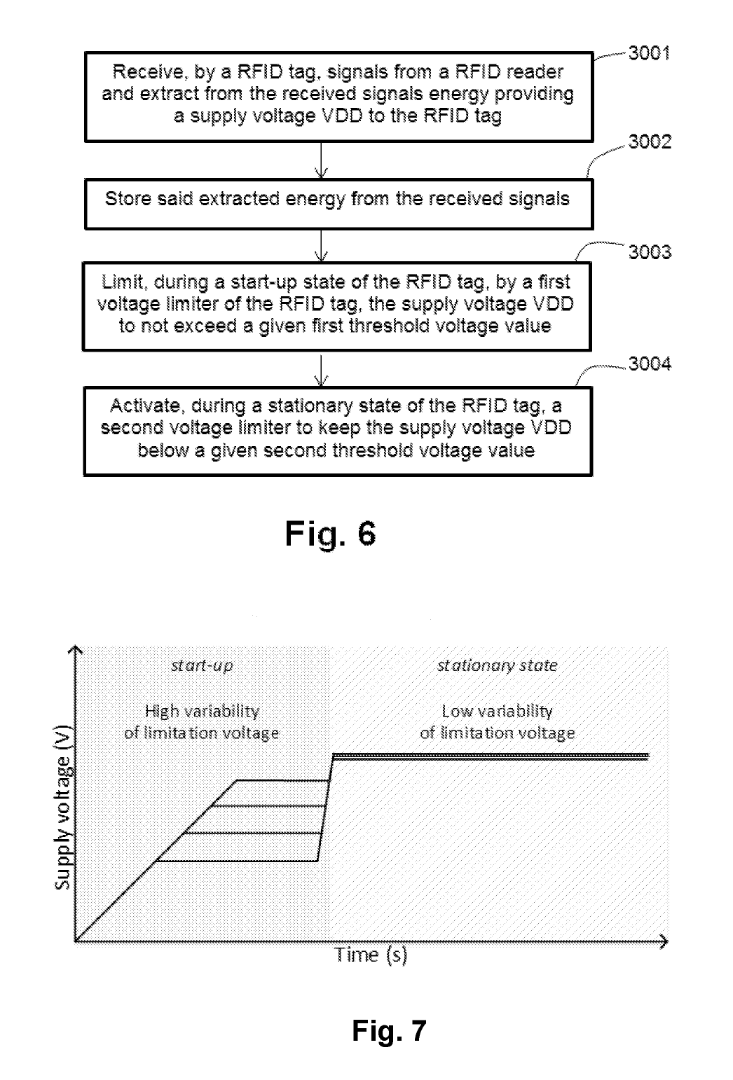

Referring now to FIG. 6, therein it is illustrated an embodiment of a method for limiting supply voltage of a RFID tag 200, either a passive or a semi-passive RFID tag. According to said method, at step 3001, a RFID tag 200 receives signals from a RFID reader 100 and extracts from the received signals energy providing a supply voltage VDD to the RFID tag 200. Then, at step 3002, the RFID tag 200 stores said extracted energy from the received signals of the RFID reader 100. Then, at step 3003, said supply voltage VDD is limited during a start-up of the RFID tag 200 by a first voltage limiter 205 of the RFID tag 200 in order the supply voltage not exceeding a given threshold voltage value of the first voltage limiter 205. Finally, at step 3004, a second voltage limiter 206 is activated/enabled during a stationary state of the RFID tag 200 to keep the supply voltage VDD below a given second threshold voltage value having a given margin of tolerance of the second voltage limiter 206.

With the energy stored in the energy storage module, the RFID tag 200 in an alternative embodiment may further power up an external device such as a sensor.

The scope of the present invention is defined in the attached claims.

1. A radio frequency identification (RFID) tag, said RFID tag comprising:
a first communication module adapted and configured to receive signals from a RFID reader, said first communication module including means for extracting energy from the received signals providing a supply voltage VDD to the RFID tag;
at least one energy storage module in connection with and supplied by the first communication module adapted and configured to store said extracted energy from the received signals of the RFID reader;
a first voltage limiter adapted and configured to limit said supply voltage VDD in order the latter not exceeding a given first threshold voltage value of the first voltage limiter comprised in a region between two given lower and upper voltage thresholds; and
a second voltage limiter, different to said first voltage limiter, adapted and configured to limit said supply voltage VDD in order the latter not exceeding a given second threshold voltage value of the second voltage limiter comprised in a region between two given lower and upper voltage thresholds, wherein:
said first voltage limiter is further adapted and configured to operate without a reference voltage of internal circuitry of the RFID tag during a start-up state thereof, wherein said start-up state comprising a time period in which the RFID tag powers up charging the energy storage module to a given voltage value and stabilizes; and
said second voltage limiter is synchronized with said first voltage limiter to switch after said stabilization of the RFID tag from said first voltage limiter to the second voltage limiter, the latter being enabled during a stationary state of the RFID tag in which a reference voltage signal VBG is available in the internal circuitry of the RFID tag, said reference voltage signal VBG being used for said switching,
wherein the first voltage limiter having a fast response time and the second voltage limiter having high and accurate limitation voltage in powered operation, so that the supply voltage VDD of the RFID tag being kept always below said given second threshold voltage value of the second voltage limiter, the given second threshold voltage value having a given margin of tolerance.

2. The RFID tag of claim 1, further comprising a digital logic controller in connection with said first and second voltage limiters to control the operation thereof during said start-up state and said stationary state of the RFID tag.

3. The RFID tag of claim 1, wherein both the first and second voltage limiters are circuits connected in parallel.

4. The RFID tag of claim 3, wherein the first and second voltage limiters comprises one or more Zener diodes.

5. The RFID tag of claim 1, wherein said given lower and upper voltage thresholds of the first voltage limiter are 1.2 V and 3.6 V, respectively, and wherein said given second threshold voltage value with the given margin of tolerance of the second voltage limiter is 3.3 V±50 mV.

6. The RFID tag of claim 1, wherein the first voltage limiter comprises:
a first stage dependent on a CMOS transistor threshold voltage arranged to generate a trigger signal when the supply voltage VDD exceeds said given first threshold voltage value of the first voltage limiter;
a second stage arranged to multiply and rectify said generated trigger signal; and
a third stage controlled by said second stage via a transistor that sinks a current from said supply voltage VDD maintaining its value below the given first threshold voltage value of the first voltage limiter.

7. The RFID tag of claim 6, wherein the second voltage limiter comprises:
a first stage including a comparator between said reference voltage signal VBG and a voltage VDDO proportional to said supply voltage VDD triggering an output signal when the supply voltage VDD is at least greater than said given second threshold voltage value of the second voltage limiter;
a second stage arranged to multiply and rectify said triggered output signal; and
a third stage controlled by said second stage via a transistor that sinks a current from said supply voltage VDD maintaining its value below the given second threshold voltage value of the second voltage limiter.

8. The RFID tag of claim 7, wherein the second stage of the first voltage limiter and the second stage of the second voltage limiter share a same group of components and both voltage limiters are interconnected.

9. The RFID tag of claim 1, further comprising:
a second communication module adapted and configured to communicate with at least one external device; and
a power output in connection with and supplied by the second communication module adapted and configured to provide a power-supply voltage to said at least one remote device using said stored energy.

10. The RFID tag of claim 1, comprising a passive RFID tag.

11. The RFID tag of claim 1, comprising a semi-passive RFID tag, the RFID tag further comprising a battery.

12. A method for limiting supply voltage of a radio frequency identification (RFID) tag, comprising:
receiving, by a first communication module of said RFID tag, signals from a RFID reader, and extracting energy from the received signals providing a supply voltage VDD to the RFID tag;
storing in at least one energy storage module of the RFID tag said extracted energy from the received signals of the RFID reader;
limiting, by a first voltage limiter, said supply voltage VDD in order the latter not exceeding a given first threshold voltage value of the first voltage limiter comprised in a region between two given lower and upper voltage thresholds; and
limiting, by a second voltage limiter different to said first voltage limiter, said supply voltage VDD in order the latter not exceeding a given second threshold voltage value of the second voltage limiter comprised in a region between two given lower and upper voltage thresholds,
wherein:
said first voltage limiter operates without a reference voltage of internal circuitry of the RFID tag during a start-up state thereof, wherein said start-up state comprising a time period in which the RFID tag powers up charging the energy storage module to a given voltage value and stabilizes; and
said second voltage limiter, is synchronized with said first voltage limiter, by switching, after said stabilization of the RFID tag, from the first voltage limiter to the second voltage limiter, the latter being enabled during a stationary state of the RFID tag in which a reference voltage signal VBG is available in the internal circuitry of the RFID tag, said reference voltage signal VBG being used for said switching,
wherein the first voltage limiter having a fast response time and the second voltage limiter having high and accurate limitation voltage in powered operation, so that the supply voltage VDD of the RFID tag is kept below said given second threshold voltage value of the second voltage limiter, the given second threshold voltage value having a given margin of tolerance.

13. The method of claim 12, further comprising providing via a power output of the RFID tag in connection with and supplied by a second communication module of the RFID tag a power-supply voltage to an external device using said stored energy.
